(19) United States
(12) Patent Application Publication
(10) Pub. No.: US 2020/0251992 A1
(43) Pub. Date: Aug. 6, 2020

(54) FLYBACK POWER-CONVERTING DEVICE WITH ZERO-VOLTAGE SWITCHING AND METHOD FOR FLYBACK CONVERTING POWER WITH ZERO-VOLTAGE SWITCHING

(71) Applicant: Chicony Power Technology Co., Ltd., New Taipei City (TW)

(72) Inventors: Tso-Jen PENG, New Taipei City (TW); Ssu-Hao WANG, New Taipei City (TW)

(21) Appl. No.: 16/744,491

(22) Filed: Jan. 16, 2020

Related U.S. Application Data
(60) Provisional application No. 62/800,048, filed on Feb. 1, 2019.

(30) Foreign Application Priority Data
Sep. 9, 2019 (TW) 108132489

(51) Int. Cl. H02M 3/335

(52) U.S. Cl. CPC H02M 3/3353; H02M 3/33507

(57) ABSTRACT

A flyback power-converting device includes a transformer circuit, a clamp damping circuit, a first switch, a voltage-reducing circuit and a second switch. The clamp damping circuit and the first switch are coupled to the transformer circuit. The voltage-reducing circuit and the second switch are coupled in series between the clamp damping circuit and the transformer circuit. Through switching of the first switch, the transformer circuit converts an input power to generate a first converted voltage and to enable the clamp damping circuit to store an inductive energy. In addition, when the second switch is turned on, the clamp damping circuit releases the inductive energy to the transformer circuit via the voltage-reducing circuit, so that the transformer circuit generates a second converted voltage according to the inductive energy.

### CROSS-REFERENCES TO RELATED APPLICATIONS

This application claims the priority benefit of U.S. provisional application Ser. No. 62/800,048, filed on Feb. 1, 2019 and Patent Application No. 108132489 filed in Taiwan, R.O.C. on Sep. 9, 2019. The entirety of the above-mentioned patent applications are hereby incorporated by references herein and made a part of the specification.

### BACKGROUND

### Technical Field

The present invention relates to a power device, and in particular, to a flyback power-converting device and a method for flyback converting power.

### Related Art

With the development of science and technology, electronic devices occupy an important position in our daily lives, and a main power source on which the electronic devices depend is still direct current power. However, a mains is mainly alternating current power. Therefore, the electronic devices are usually coupled to the alternating current power via an adapter, and a power-converting device in the adapter converts the alternating current power of the mains into direct current power, to supply electric power needed by the electronic devices to operate.

In the application of power-converting devices, a flyback converter circuit architecture is the most common. A flyback power-converting device has advantages such as circuit isolation, simple structure and low costs. The flyback power-converting device is mainly an active clamp flyback (ACF) power-converting device and a passive clamp flyback power-converting device (or referred to as an inactive clamp flyback power-converting device). To miniaturize the adapter, the active clamp flyback power-converting device becomes an increasingly valued power-converting technology.

In the active clamp flyback power-converting device, a snubber diode in the passive clamp flyback power-converting device is replaced by an auxiliary switch, to reduce switching loss, and further improve overall efficiency of a converter. In use, to have higher efficiency, the active clamp flyback power-converting device operates in a flyback mode (that is, the auxiliary switch is not working) in light-load, and operates in an active mode (that is, the auxiliary switch is working) in heavy-load. However, when the auxiliary switch is working, a surge current is generated on a secondary side, thereby damaging internal components.

### SUMMARY

In an embodiment, a flyback power-converting device includes: a transformer circuit, a clamp damping circuit, a first switch, a voltage-reducing circuit and a second switch. The clamp damping circuit and the first switch are coupled to the transformer circuit. The voltage-reducing circuit is coupled in series with the voltage-reducing circuit between the clamp damping circuit and the transformer circuit.

Through switching of the first switch, the transformer circuit converts an input power to generate a first converted voltage and to enable the clamp damping circuit to store an inductive energy. In addition, when the second switch is turned on, the clamp damping circuit releases the inductive energy to the transformer circuit via the voltage-reducing circuit, so that the transformer circuit generates a second converted voltage according to the inductive energy.

In an embodiment, a method for flyback converting power includes: storing a conversion energy in a primary side winding of a transformer circuit, transferring the conversion energy stored in the primary side winding to a secondary side winding of the transformer circuit to enable an energy-storage element to store an inductive energy; and releasing, by a voltage-reducing element, the inductive energy stored in the energy-storage element to the primary side winding.

In conclusion, according to the flyback power-converting device and the method for flyback converting power of the present invention, a surge current can be prevented from being generated on a secondary side when the clamp damping circuit releases energy via an auxiliary switch (that is, the second switch), thereby reducing impact on internal components to extend a product service time, restoring the inductive energy to improve produce efficiency, and selecting a relatively low semiconductor rated voltage or current value to reduce costs.

### BRIEF DESCRIPTION OF THE DRAWINGS

FIG. 1 is a block diagram of functions of a flyback power-converting device according to an embodiment;

FIG. 2 is a block diagram of functions of a flyback power-converting device according to another embodiment;

FIG. 3 is an exemplary brief circuit diagram of the flyback power-converting device of FIG. 1;

FIG. 4 is an exemplary brief circuit diagram of the flyback power-converting device of FIG. 2;

FIG. 5 is a timing diagram of a switch signal in an active mode of the flyback power-converting device of FIG. 3;

FIG. 6 is a flowchart of a method for flyback converting power according to an embodiment;

FIG. 7 to FIG. 9 are each a schematic diagram of actions in the active mode of the flyback power-converting device of FIG. 3;

FIG. 10 is an equivalent circuit diagram of the flyback power-converting device of FIG. 9;

FIG. 11 is a timing diagram of a switch signal in a flyback mode of the flyback power-converting device of FIG. 3;

FIG. 12 is a schematic diagram of actions of a step in the flyback mode of the flyback power-converting device of FIG. 3; and

FIG. 13 is block diagram of functions of an adapter according to an embodiment.

### DETAILED DESCRIPTION

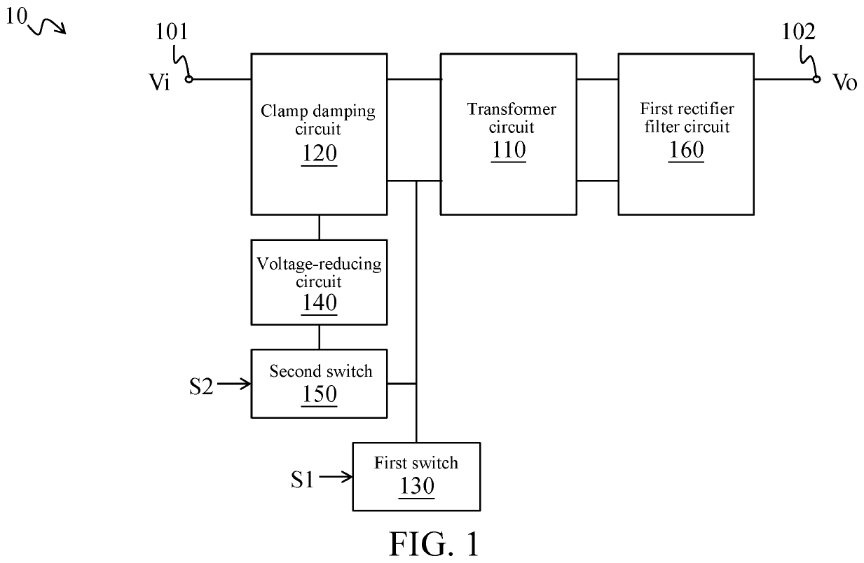

Referring to FIG. 1, a flyback power-converting device 10 includes a transformer circuit 110, a clamp damping circuit 120, a first switch 130, a voltage-reducing circuit 140 and a second switch 150.

The clamp damping circuit 120 is coupled to a primary side of the transformer circuit 110. In this case, the clamp damping circuit 120 is connected in parallel with the primary side of the transformer circuit 110, that is, the clamp damping circuit 120 is coupled between a first end and a second end of the primary side of the transformer circuit 110. In addition, the first end of the primary side of the transformer circuit 110 is further coupled to an input end 101.

The first switch 130 is coupled between the second end of the primary side of the transformer circuit 110 and a ground. In this case, through switching of the first switch 130, the transformer circuit 110 converts an input power Vi to generate a converted voltage (referred to as a first converted voltage below) and to enable the clamp damping circuit 120 to store an inductive energy.

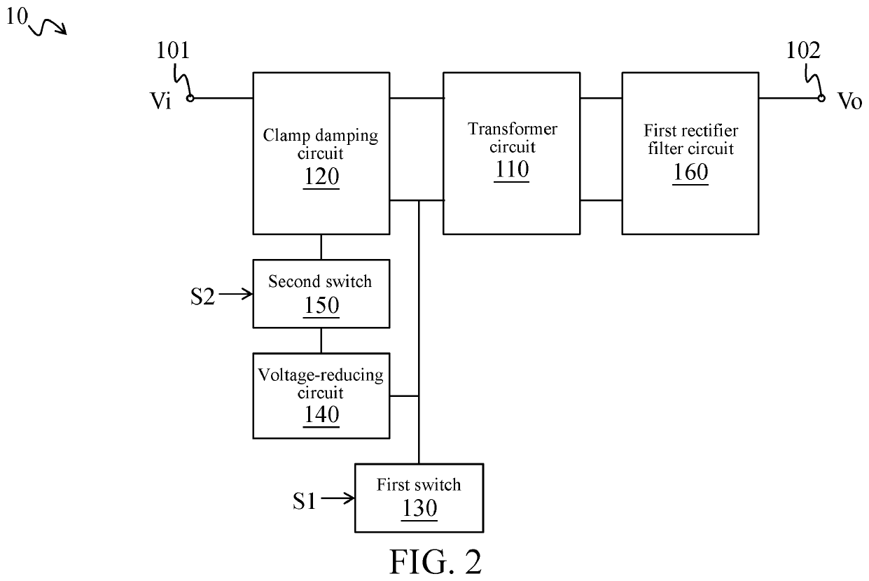

An energy-releasing path is further coupled between the clamp damping circuit 120 and the second end of the primary side of the transformer circuit 110. The voltage-reducing circuit 140 and the second switch 150 are disposed on the energy-releasing path. In other words, the voltage-reducing circuit 140 is coupled between the clamp damping circuit 120 and the second end of the primary side of the transformer circuit 110. The second switch 150 is coupled in series with the voltage-reducing circuit 140 between the clamp damping circuit 120 and the second end of the primary side of the transformer circuit 110. In this case, the second switch 150 is configured to turn on or cut off the energy-releasing path. When the second switch 150 is turned on, the clamp damping circuit 120 releases the inductive energy to the transformer circuit 110 via the voltage-reducing circuit 140, so that the transformer circuit 110 generates another converted voltage (referred to as a second converted voltage below) according to the inductive energy. In an example, the voltage-reducing circuit 140 is coupled between the clamp damping circuit 120 and a first end of the second switch 150, and a second end of the second switch 150 is coupled to the second end of the primary side of the transformer circuit 110, as shown in FIG. 1. In another example, the clamp damping circuit 120 is coupled to the first end of the second switch 150, and the voltage-reducing circuit 140 is coupled between the second end of the second switch 150 and the second end of the primary side of the transformer circuit 110, as shown in FIG. 2. In some embodiments, the second converted voltage is less than the first converted voltage.

In some embodiments, the flyback power-converting device 10 further includes: a rectifier filter circuit (referred to as a first rectifier filter circuit 160 below). The first rectifier filter circuit 160 is coupled between a secondary side of the transformer circuit 110 and an output end 102. When the transformer circuit 110 generates the first converted voltage, the first rectifier filter circuit 160 receives the first converted voltage and generates an output voltage Vo at the output end 102 according to the first converted voltage. When the transformer circuit 110 generates the second converted voltage, the first rectifier filter circuit 160 cuts off an output path because the second converted voltage is less than the output voltage Vo.

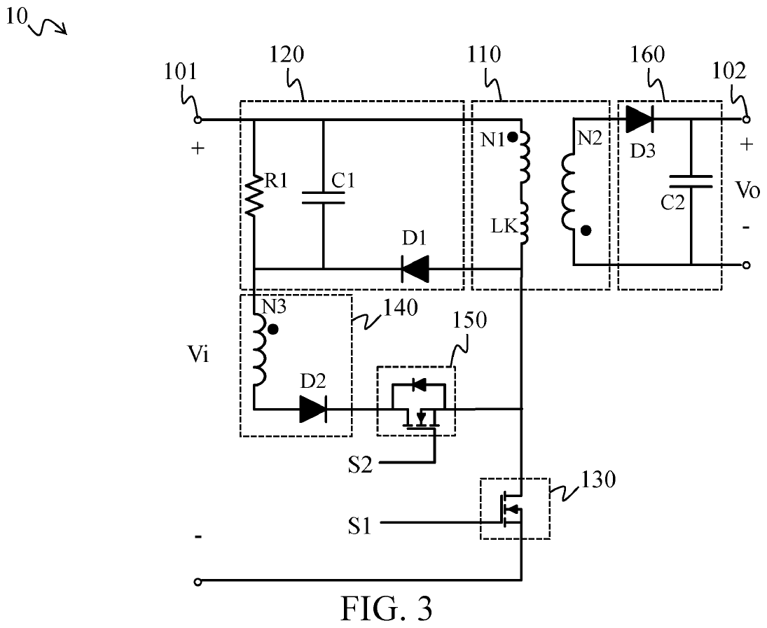

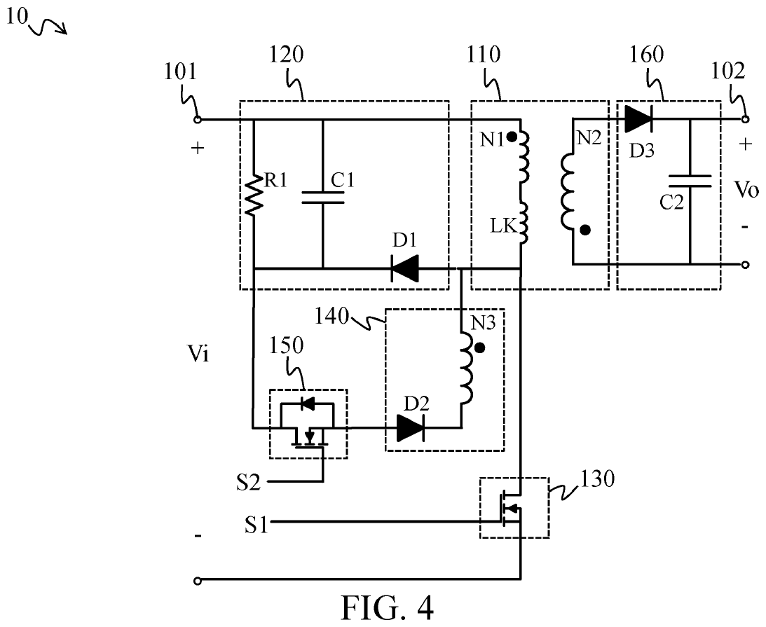

In some embodiments, referring to FIG. 3 and FIG. 4, the transformer circuit 110 includes a primary side winding N1 and a secondary side winding N2. The primary side winding N1 and the secondary side winding N2 are inductively coupled to each other.

A first end of the clamp damping circuit 120 is coupled to a first end of the primary side winding N1. A second end of the clamp damping circuit 120 is coupled to the voltage-reducing circuit 140 (as shown in FIG. 3) or is coupled to the second switch 150 (as shown in FIG. 4). A third end of the clamp damping circuit 120 is coupled to the output end 102. In some embodiments, the clamp damping circuit 120 includes an energy-storage element C1 and a forward conduction element D1. One end (that is, the first end of the clamp damping circuit 120) of the energy-storage element C1 is coupled to the first end of the primary side winding N1 and the output end 102. The other end (that is, the second end of the clamp damping circuit 120) of the energy-storage element C1 is coupled to the voltage-reducing circuit 140 (as shown in FIG. 3) or is coupled to the first end of the second switch 150 (as shown in FIG. 4). In this case, the other end of the energy-storage element C1 is further coupled to a cathode of the forward conduction element D1. An anode (that is, the third end of the clamp damping circuit 120) of the forward conduction element D1 is coupled to a second end of the primary side winding N1. In some embodiments, the clamp damping circuit 120 may further include a resistor R1, and the resistor R1 is connected in parallel with the energy-storage element C1. The energy-storage element C1 may be a capacitor.

In some embodiments, a first end of the first switch 130 is coupled to the second end of the primary side winding N1. A second end of the first switch 130 is coupled to the ground. A control end of the first switch 130 is coupled to a pulse width modulation (PWM) controller (not shown). The first switch 130 may be a N-type metal-oxide-semiconductor FET (NMOSFET). In this case, the first end, the second end and the control end of the first switch 130 are respectively a drain, a source and a gate.

In some embodiments, the voltage-reducing circuit 140 includes a voltage-reducing element N3. In an example, the voltage-reducing element N3 is coupled between the other end of the energy-storage element C1 and the first end of the second switch 150, as shown in FIG. 3. In another example, the voltage-reducing element N3 is coupled between the second end of the second switch 150 and the second end of the primary side winding N1, as shown in FIG. 4. In some embodiments, the voltage-reducing circuit 140 may further include a forward conduction element D2. The forward conduction element D2 is coupled to any position of the energy-releasing path in a manner of using a direction in which a current flows from the energy-storage element C1 to the second end of the primary side winding N1 as a forward direction. For example, the voltage-reducing element N3, the forward conduction element D2 and the second switch 150 are sequentially coupled in series between the other end of the energy-storage element C1 and the second end of the primary side winding N1, as shown in FIG. 3. Alternatively, the second switch 150, the forward conduction element D2 and the voltage-reducing element N3 are sequentially coupled in series between the other end of the energy-storage element C1 and the second end of the primary side winding N1, as shown in FIG. 4. Alternatively, the forward conduction element D2, the second switch 150 and the voltage-reducing element N3 are sequentially coupled in series between the other end of the energy-storage element C1 and the second end of the primary side winding N1, which is not shown. Alternatively, the second switch 150, the voltage-reducing element N3 and the forward conduction element D2 are sequentially coupled in series between the second end of the primary side winding N1 and the other end of the energy-storage element C1, which is not shown. Alternatively, the voltage-reducing element N3, the second switch 150 and the forward conduction element D2 are sequentially coupled in series between the other end of the energy-storage element C1 and the second end of the primary side winding N1, which is not shown. Alternatively, the forward conduction element D2, the voltage-reducing element N3 and the second switch 150 are sequentially coupled in series between the other end of the energy-storage element C1 and the second end of the primary side winding N1, which is not shown. In this case, the forward conduction element D2 limits an output current of the transformer circuit 110 from flowing through a parasitic diode of the second switch 150. The voltage-reducing element N3 may be an auxiliary winding. The second switch 150 may be an NMOSFET. In this case, the first end, the second end and the control end of the first switch 130 are respectively the drain, the source and the gate. In some embodiments, the primary side winding N1 and the auxiliary winding (that is, the voltage-reducing element N3) may be enwound on a same reel. That is, the primary side winding N1 and the auxiliary winding have a same polarity.

The first rectifier filter circuit 160 includes a secondary rectifier circuit. The secondary rectifier circuit may include a forward conduction element D3. An anode of the forward conduction element D3 is coupled to a first end of the secondary side winding N2, and a cathode of the forward conduction element D3 is coupled to the output end 102. In this case, when the transformer circuit 110 generates the second converted voltage, the forward conduction element D3 is cut off because the second converted voltage is less than the output voltage Vo. In some embodiments, the first rectifier filter circuit 160 may further include a secondary filter circuit. The secondary filter circuit may include an output capacity C2, and the output capacity C2 is coupled to the output end 102.

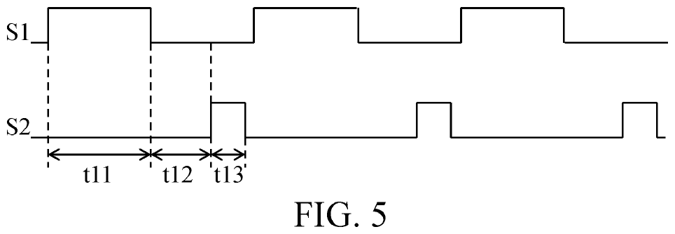

In an operation of an active mode, taking a circuit architecture shown in FIG. 3 as an example, the control end of the first switch 130 receives a switch signal (referred to as a first switch signal S1 below), and a control end of the second switch 150 receives another switch signal (referred to as a second switch signal S2 below). Timing of the first switch signal Si and the second switch signal S2 is shown in FIG. 5.

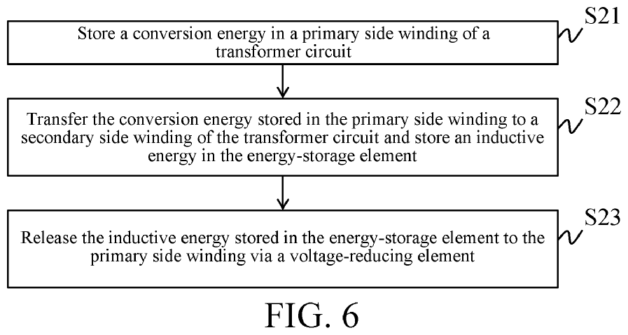

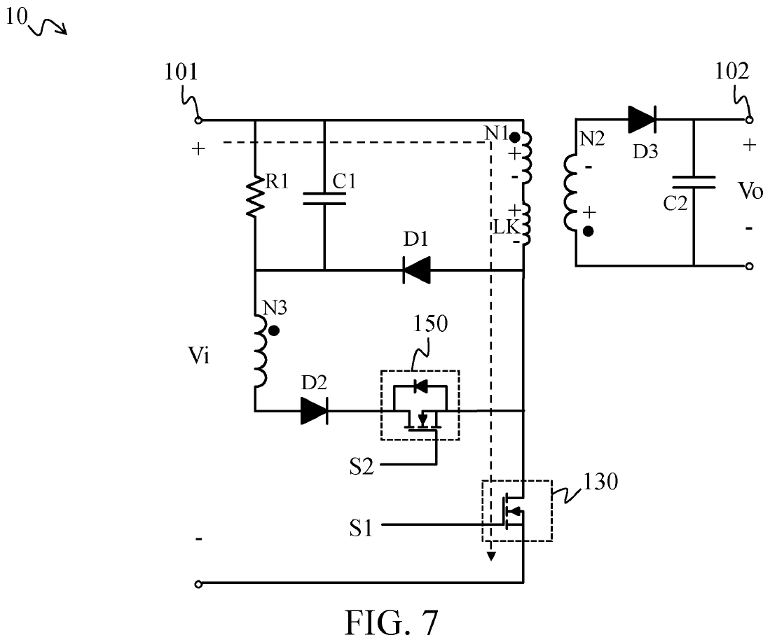

Referring to FIG. 3, FIG. 5 and FIG. 6, during a first time t11, the first switch 130 is turned on, and the second switch 150 is cut off; in this case, the primary side winding N1 receives the input power Vi to store a conversion energy (step S21), as shown in FIG. 7. In FIG. 7, dotted arrows indicate current directions.

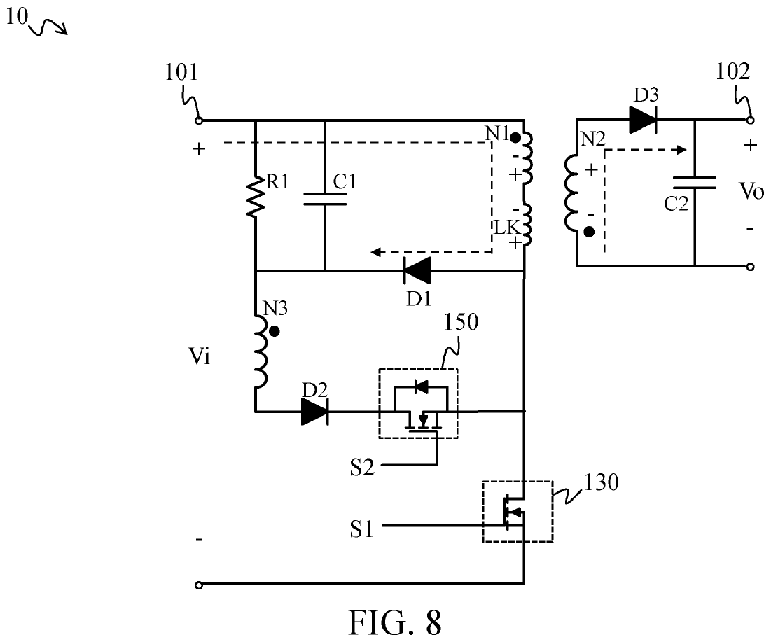

During a second time t12, the first switch 130 is cut off, and the second switch 150 is cut off; in this case, the conversion energy stored in the primary side winding N1 is transferred to the secondary side winding N2, that is, the transformer circuit 110 transfers the input power Vi to a converted voltage via an electromagnetic coupling between the primary side winding N1 and the secondary side winding N2, and charges the energy-storage element C1 via the forward conduction element D1, to enable the energy-storage element C1 to store the inductive energy (step S22), as shown in FIG. 8. In this case, a voltage Vcl in the energy-storage element C1 is NVo+Vlk. N is a ratio of winding of the primary side winding N1 and the secondary side winding N2, and Vlk is an induced voltage of a leakage Lk generated by the primary side winding In FIG. 8, dotted arrows indicate current directions.

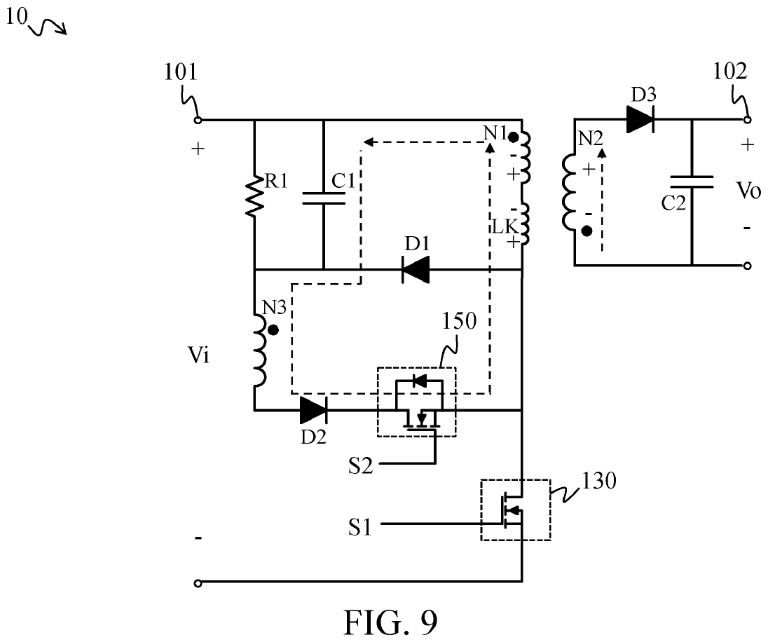

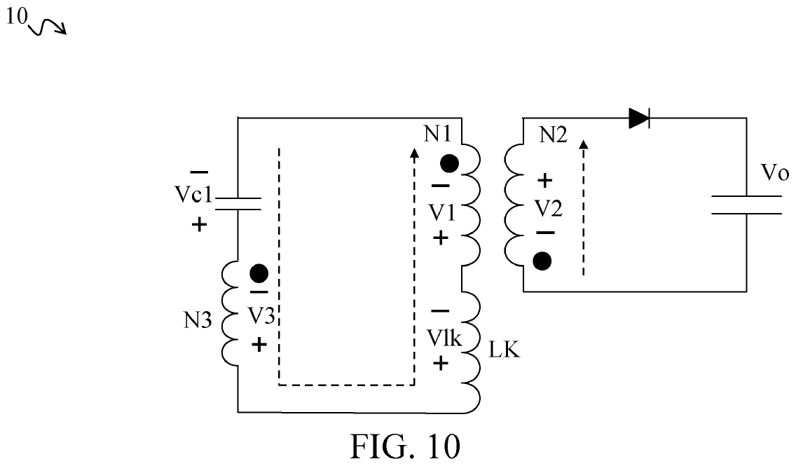

During a third time t13, the first switch 130 is cut off, and the second switch 150 is turned on; in this case, the energy-storage element C1 releases the stored inductive energy to the primary side winding N1 via the voltage-reducing element N3 and transfers to the secondary side winding N2 via the electromagnetic coupling between the primary side winding N1 and the secondary side winding N2 (step S23), as shown in FIG. 9. In this case, an equivalent circuit of the flyback power-converting device 10 is as shown in FIG. 10. After voltage reducing via the voltage-reducing element N3, a converted voltage (V2) generated by the secondary side winding N2 is less than the output voltage Vo. Therefore, the forward conduction element D3 is cut off. In FIG. 9 and FIG. 10, dotted arrows indicate current directions. V1 is an induced voltage of the primary side winding N1.

For example, assuming that the output voltage Vo is fixed to 20 V (volt), a turn number of the primary side winding N1 is 6, a turn number of the secondary side winding N2 is 1, a turn number of the auxiliary winding (that is, the voltage-reducing element N3) is 1, and the induced voltage Vlk of the leakage Lk is 6 V.

During the second time t12, the voltage Vcl in the energy-storage element C1 is 126 V as shown in the following formula 1.

$$\begin{matrix}Vc 1 = NVo + V lk = ( N 1 / N 2 ) * Vo + Vlk \\ = ( 6 / 1 ) * 20 V + 6 V = 126 V\end{matrix} \qquad Formula 1$$

During the third time t13, the energy-storage element C1 releases energy, and in this case, the converted voltage V2 reflected to the secondary side winding N2 is 17.66 V, as shown in the following formula 2. V3 is an induced voltage of the auxiliary winding (that is, the voltage-reducing element N3).

V2=(Vcl−V3)*(N2/N1)=(126−20)(⅙)=126V Formula 2

In this case, because the output voltage Vo is 20 V, the converted voltage V2 reflected to the secondary side winding N2 is 17.66 V, the forward conduction element D3 located in the secondary side of the transformer circuit 110 is not turned on (that is, is cut off), therefore a situation is avoided that the secondary side of the transformer circuit 110 generates a surge current, and the energy released by the energy-storage element C1 will flow back to the energy-storage element C1.

In some embodiments, the flyback power-converting device 10 further includes a flyback mode as an action mode.

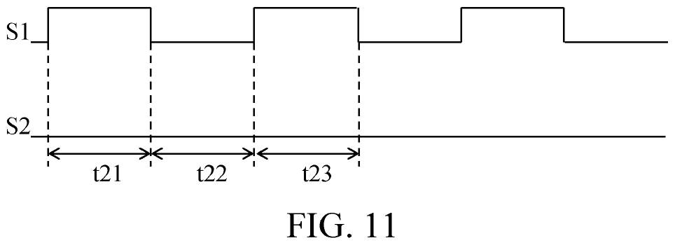

In an operation of the flyback mode, taking a circuit architecture shown in FIG. 3 as an example, the control end of the first switch 130 receives the first switch signal S1, and the control end of the second switch 150 receives the second switch signal S2. Timing of the first switch signal S1 and the second switch signal S2 is shown in FIG. 11. In this mode, the second switch signal S2 is on a cut-off level. That is, the second switch 150 remains in a cut-off state. The first switch signal 51 switches between a turned-on level and a cut-off level.

Referring to FIG. 3 and FIG. 1, during a first time t21, the first switch 130 is turned on, and the second switch 150 is turned off In this case, the primary side winding N1 receives the input power Vi to store a conversion energy, as shown in FIG. 7.

During a second time t22, the first switch 130 is cut off, and the second switch 150 is still cut off In this case, the conversion energy stored in the primary side winding N1 is transferred to the secondary side winding N2. That is, the transformer circuit 110 transfers the input power Vi to a converted voltage via an electromagnetic coupling between the primary side winding N1 and the secondary side winding N2, and charges the energy-storage element C1 via the forward conduction element D1, to enable the energy-storage element C1 to store the inductive energy, as shown in FIG. 8.

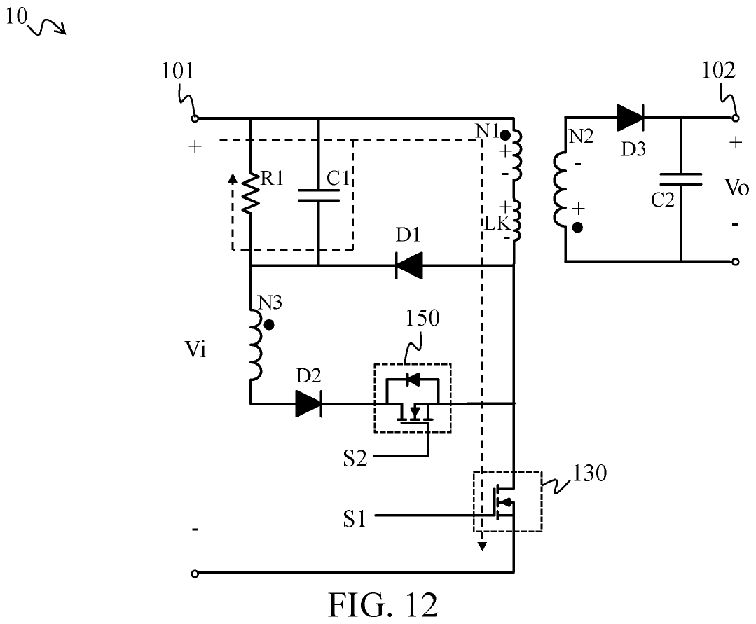

During a third time t23, the first switch 130 is turned on again, and the second switch 150 is still cut off In this case, input energy is again stored in the primary side winding N1, and the stored inductive energy in the energy-storage element C1 is released to the resistor R1, as shown in FIG. 12.

In some embodiments, the foregoing forward conduction elements D1˜D3 may be diodes.

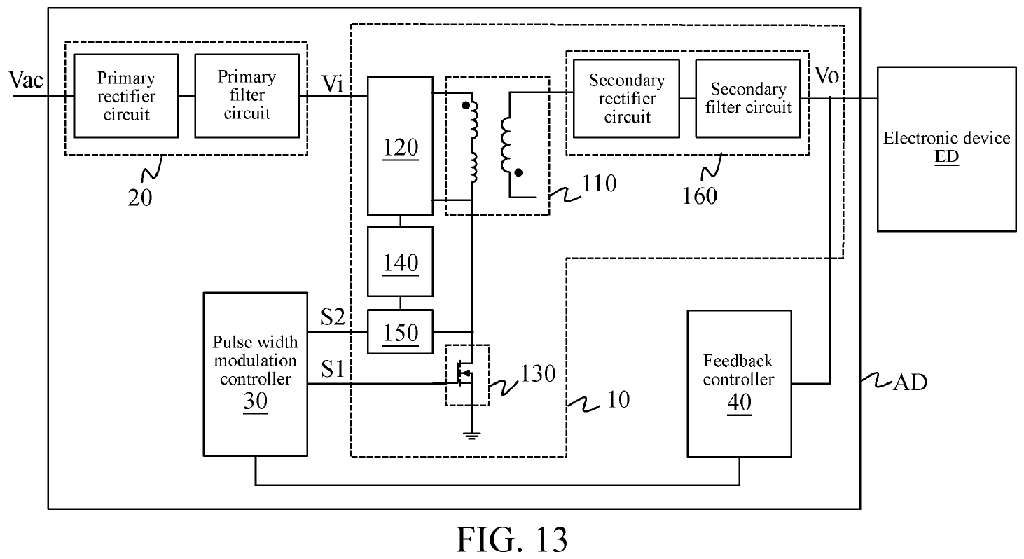

In some embodiments, referring to FIG. 13, the flyback power-converting device 10 according to any one of the foregoing embodiments is applicable to an adapter AD. An electronic device ED converts an alternating current power Vac of the mains into the direct current power (that is, the output voltage Vo) via the adapter AD, to supply electricity needed for operation.

The adapter AD includes the flyback power-converting device 10 according to any one of the foregoing embodiments, another rectifier filter circuit (referred to as a second rectifier filter circuit 20 below), a pulse width modulation controller 30 and a feedback controller 40. The second rectifier filter circuit 20 is coupled between the alternating current power Vac and the input end 101 of the flyback power-converting device 10. The pulse width modulation controller 30 is coupled to the control ends of the flyback power-converting device 10 (that is, the control end of the first switch 130 and the control end of the second switch 150). The feedback controller 40 is coupled to the output end 102 of the flyback power-converting device 10 and a feedback end of the pulse width modulation controller 30.

The feedback controller 40 converts the output voltage Vo into a feedback voltage. The pulse width modulation controller 30 generates the first switch signal S1 and the second switch signal S2 according to the feedback voltage. The second rectifier filter circuit 20 receives, and performs rectification and filtering on, the alternating current power Vac so as to generate the input power Vi for the flyback power-converting device 10. The flyback power-converting device 10, based on control of the first switch signal S1 and the second switch signal S2, converts the input power Vi into the output voltage Vo and provides the output voltage Vo for the electronic device ED. The pulse width modulation controller 30 may include a mode control circuit and a pulse width modulation generating circuit. The pulse width modulation generating circuit generates a pulse width modulation signal for the mode control circuit according to the feedback voltage. The mode control circuit generates the first switch signal S1 and the second switch signal S2 according to the feedback voltage and the pulse width modulation signal so as to control an operation mode of the flyback power-converting device 10. In some embodiments, the pulse width modulation controller 30 may be implemented by an integrated circuit (IC).

In conclusion, according to the flyback power-converting device and the method for flyback converting power of the present invention, a surge current can be prevented from being generated on a secondary side when the clamp damping circuit 120 releases energy via an auxiliary switch (that is, the second switch 150), thereby reducing impact on internal components to extend a product service time, restoring the inductive energy to improve produce efficiency, and selecting a relatively low semiconductor rated voltage or current value to reduce costs.

What is claimed is:

1. A flyback power-converting device, comprising:
a transformer circuit;
a clamp damping circuit, coupled to the transformer circuit;
a first switch, coupled to the transformer circuit, wherein through switching of the first switch, the transformer circuit converts an input power to generate a first converted voltage and to enable the clamp damping circuit to store an inductive energy;
a voltage-reducing circuit, coupled between the clamp damping circuit and the transformer circuit; and
a second switch, coupled in series with the voltage-reducing circuit between the clamp damping circuit and the transformer circuit, wherein when the second switch is turned on, the clamp damping circuit releases the inductive energy to the transformer circuit via the voltage-reducing circuit, so that the transformer circuit generates a second converted voltage according to the inductive energy.

2. The flyback power-converting device according to claim 1, wherein the transformer circuit comprises a primary side winding and a secondary side winding inductively coupled to the primary side winding, a first end of the clamp damping circuit is coupled to a first end of the primary side winding, the first switch is coupled between a second end of the primary side winding and a ground, the voltage-reducing circuit is coupled between a second end of the clamp damping circuit and a first end of the second switch, and a second end of the second switch is coupled to the second end of the primary side winding.

3. The flyback power-converting device according to claim 1, wherein the transformer circuit comprises a primary side winding and a secondary side winding inductively coupled to the primary side winding, a first end of the clamp damping circuit is coupled to a first end of the primary side winding, the first switch is coupled between a second end of the primary side winding and a ground, a second end of the clamp damping circuit is coupled to a first end of the second switch, and the voltage-reducing circuit is coupled between the second end of the primary side winding and a second end of the second switch.

4. The flyback power-converting device according to claim 1, wherein the clamp damping circuit comprises:
an energy-storage element, one end of the energy-storage element being coupled to a first end of the transformer circuit; and
a forward conduction element, coupled between a second end of the transformer circuit and the other end of the energy-storage element, wherein when the first switch is turned off, the forward conduction element is turned on, and the transformer circuit charges the energy-storage element via the forward conduction element, to enable the energy-storage element to store the inductive energy.

5. The flyback power-converting device according to claim 4, wherein the voltage-reducing circuit comprises: an auxiliary winding, and when the second switch is turned on, the energy-storage element releases the inductive energy to the transformer circuit via the auxiliary winding.

6. The flyback power-converting device according to claim 5, wherein the voltage-reducing circuit further comprises: another forward conduction element, configured to limit an output current of the transformer circuit from flowing through a parasitic diode of the second switch.

7. The flyback power-converting device according to claim 1, wherein the voltage-reducing circuit comprises: an auxiliary winding, and when the second switch is turned on, the clamp damping circuit releases the inductive energy to the transformer circuit via the auxiliary winding.

8. The flyback power-converting device according to claim 7, wherein the voltage-reducing circuit further comprises: a forward conduction element, configured to limit an output current of the transformer circuit from flowing through a parasitic diode of the second switch.

9. A method for flyback converting power, comprising:
storing a conversion energy in a primary side winding of a transformer circuit;
transferring the conversion energy stored in the primary side winding to a secondary side winding of the transformer circuit to store an inductive energy in an energy-storage element; and
releasing, by a voltage-reducing element, the inductive energy stored in the energy-storage element to the primary side winding.

10. The method for flyback converting power according to claim 9, wherein the voltage-reducing element is an auxiliary winding.
